(19) United States
(12) Patent Application Publication
(10) Pub. No.: US 2022/0397556 A1
(43) Pub. Date: Dec. 15, 2022

(54) SYSTEM AND METHOD FOR DETECTING IRREGULARITIES THROUGH SUBMERSIBLE OPERATION

(71) Applicant: Ipipe Ltd., Jerusalem (IL)

(72) Inventors: Menashe RAJUAN, Jerusalem (IL); Shimon MIZRAHI, Jerusalem (IL); Binyamin SHMID, Givat Zeev (IL)

(73) Assignee: Ipipe Ltd., Jerusalem (IL)

(21) Appl. No.: 17/777,281

(22) PCT Filed: Nov. 18, 2020
(86) PCT No.: PCT/IL2020/051195

§ 371 Date: May 17, 2022

Related U.S. Application Data
(60) Provisional application No. 62/936,645, filed on Nov. 18, 2019.

(51) Int. Cl. G01N 29/14; F16L 55/48; G01N 29/34

(52) U.S. Cl. CPC G01N 29/14; F16L 55/48; G01N 29/348; F16L 2101/30

(57) ABSTRACT

Disclosed herein is a submersible having one or more sensors configured to collect a signal from an interior area of a liquid carrying channel, and a processor configured to obtain the signal from the one or more sensors, calculate a diameter and a circumference of the liquid carrying channel according to the signal. determine whether an irregularity is present on an inner surface of the liquid carrying channel according to the diameter and the circumference, and generate a notification to notify an irregularity has been detected on the inner surface.

### FIELD OF THE INVENTION

The present disclosure generally relates to submersibles.

### BACKGROUND

Liquid carrying channels, such as pipes, sewers and canals, carrying fluids require maintenance to prevent damage and leaks resulting in expensive repairs and financial loss. Detection of the damage and irregularities in the liquid carrying channels need to occur efficiently and timely thereby avoiding excessive damage and costly repairs. Due to the large distribution networks as well as sanitation, these require a very extensive and intricate infrastructure that has to be regularly maintained and repaired. The faster leaks and damage is detected, the smaller the damage to the infrastructure and its surrounding area.

### SUMMARY

The following embodiments and aspects thereof are described and illustrated in conjunction with systems, tools and methods which are meant to be exemplary and illustrative, not limiting in scope.

There is provided with an embodiment, a submersible including at least one sensor configured to collect a signal from within an interior area of a liquid carrying channel, and at least one processor configured to obtain the signal from the at least one sensor, calculate a diameter and a circumference of a liquid carrying channel according to the signal, determine whether an irregularity is present on an inner surface of the liquid carrying channel according to the diameter and the circumference, and generate a notification to notify a detection of the irregularity on the inner surface.

In some embodiments, the diameter and the circumference are compared with a calibration diameter and a calibration circumference to determine whether the irregularity is detected on the inner surface.

In some embodiments, the submersible further includes a propulsion system operative to facilitate realigning the liquid proof external casing with a predetermined point of reference.

In some embodiments, the at least one processor is further configured to compare the diameter and the circumference with the calibration diameter and the calibration circumference, determine the housing has deviated from a central longitudinal axis of the liquid carrying channel, operate the propulsion system to realign housing with the central longitudinal axis.

In some embodiments, the submersible further includes an emission unit configured to emit a signal through the liquid carrying channel.

In some embodiments, the emission unit is a light emitter for emitting a light ring, and the sensor is an imaging sensor for collecting at least one image. In some embodiments, the emission unit is a sound emitter for emitting a sound of a predetermined wavelength, and the sensor is a microphone for collecting reflected sound waves.

In some embodiments, the submersible further includes a transmitter for transmitting the notification to a computer.

In some embodiments, the transmitter facilitates remote operation of the at least one processor by a user of the computer.

There is further provided with an embodiment, a system configured to detect irregularities in a liquid carrying channel, the system including a submersible having at least one sensor configured to obtain a signal from within an internal area and surface of the liquid carrying channel, and at least one processor configured to obtain the signal from the at least one sensor, calculate a diameter and a circumference of a liquid carrying channel according to the signal, determine whether an irregularity is present on an inner surface of the liquid carrying channel according to the diameter and the circumference, and generate a notification to notify a detection of the irregularity on the inner surface.

In certain embodiments, the diameter and the circumference are compared with a calibration diameter and a calibration circumference to determine whether the irregularity is detected on the inner surface.

In certain embodiments, the submersible further comprises a propulsion system operative to facilitate realigning the liquid proof external casing with a predetermined point of reference.

In certain embodiments, the at least one processor is further configured to compare the diameter and the circumference with the calibration diameter and the calibration circumference, determine the housing has deviated from a central longitudinal axis of the liquid carrying channel, and, operate the propulsion system to realign housing with the central longitudinal axis.

In certain embodiments, the submersible further comprises an emission unit configured to emit a signal through the liquid carrying channel.

In certain embodiments, the emission unit is a light emitter for emitting a light ring, and the sensor is an imaging sensor for collecting at least one image.

In certain embodiments, the emission unit is a sound emitter for emitting a sound of a predetermined wavelength, and the sensor is a microphone for collecting reflected sound waves.

In certain embodiments, the system further includes a computer and, transmitter for transmitting the notification to the computer.

In certain embodiments, the transmitter facilitates remote operation of the submersible by a user of the computer.

In addition to the exemplary aspects and embodiments described above, further aspects and embodiments will become apparent by reference to the figures and by study of the following detailed description.

### BRIEF DESCRIPTION OF THE DRAWINGS

Some non-limiting exemplary embodiments or features of the disclosed subject matter are illustrated in the following drawings.

FIG. 1 schematically illustrates a system for operating a submersible for detecting irregularities in a liquid carrying channel, according certain exemplary embodiments;

FIG. 2 schematically illustrates the submersible for detecting irregularities in a liquid carrying channel, according to certain exemplary embodiments;

FIGS. 3A-3E show the submersible positioned in the liquid carrying channel, according to certain exemplary embodiments;

FIG. 4 outlines operations for calibrating the submersible, according to certain exemplary embodiments;

FIG. 5 outlines operations for realigning the submersible along a central longitudinal axis of the liquid carrying channel, according to certain exemplary embodiments; and,

FIG. 6 outlines operations for detecting irregularities on the liquid carrying channel, according to certain exemplary embodiments.

Identical, duplicate, equivalent or similar structures, elements, or parts that appear in one or more drawings are generally labeled with the same reference numeral, optionally with an additional letter or letters to distinguish between similar entities or variants of entities, and may not be repeatedly labeled and/or described.

Dimensions of components and features shown in the figures are chosen for convenience or clarity of presentation and are not necessarily shown to scale or true perspective. For convenience or clarity, some elements or structures are not shown or shown only partially and/or with different perspective or from different point of views. References to previously presented elements are implied without necessarily further citing the drawing or description in which they appear.

### DETAILED DESCRIPTION

Disclosed herein is a system and method for operating a submersible for detecting irregularities in a liquid carrying channel, according certain exemplary embodiments.

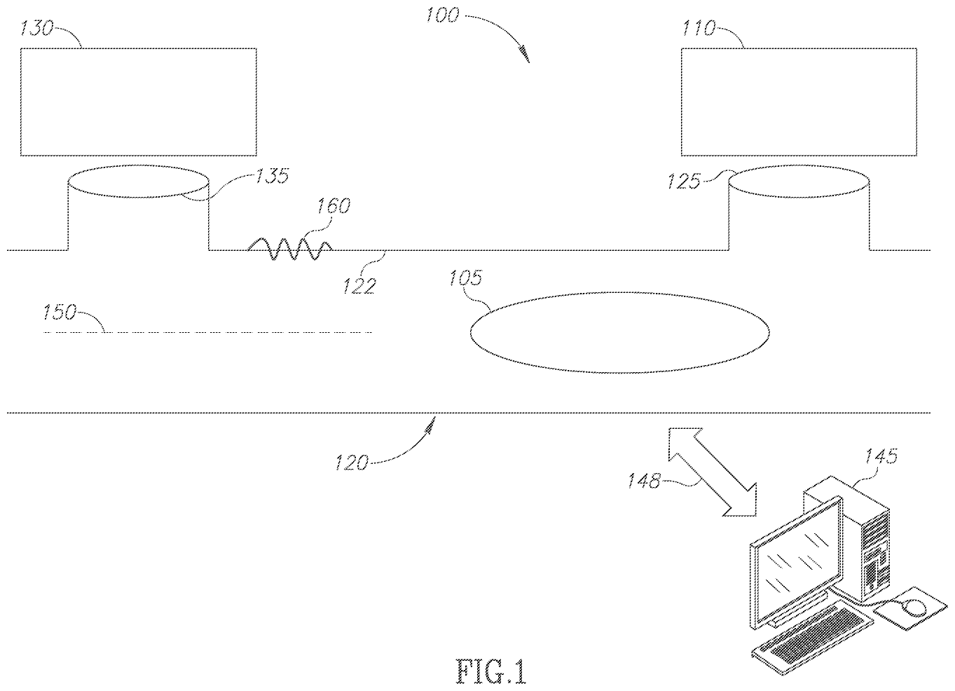

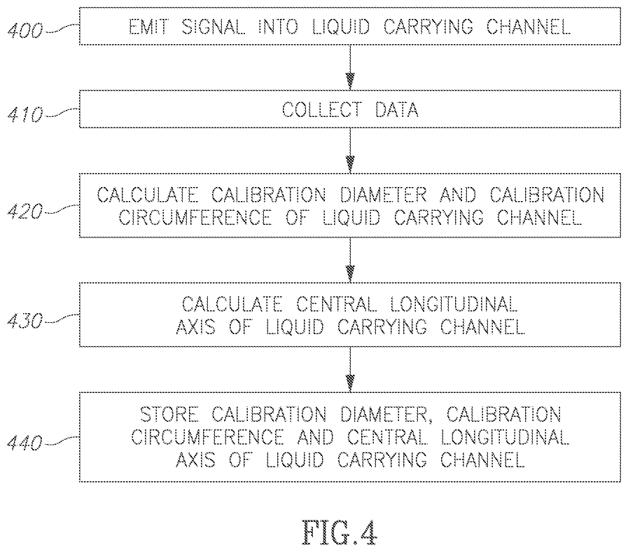

As will be seen with reference to FIG. 1, schematically illustrating a system 100 including a submersible 105 for detecting irregularities, generally referenced 160, of a liquid carrying channel 120, according to certain exemplary embodiments. In some embodiments, the irregularity is an object protruding into an inner area of liquid carrying channel 120, or a leak and damage caused to the liquid carrying channel 120 due to, for example, corrosion, objects hitting the liquid carrying channel 120, or the like. It is appreciated by one skilled in the art that liquid carrying channel 120 can have any geometric shape, such as a cylindrical shape, rectangular shape, pentagonal shape, or the like. System 100 includes a launch unit 110 configured to insert submersible 105 into a first opening 125 of liquid carrying channel 120. Launch unit 110 is configured to insert submersible 105 to be aligned in parallel with a central longitudinal axis 150 of liquid carrying channel 120. It is appreciated by one skilled in the art that the central longitudinal axis 150 is parallel to the orientation of inner surface 122 of liquid carrying channel 120. System 100 includes a collection unit 130 for extracting submersible 100 from a second opening 135 of liquid carrying channel 120. System 100 includes computer 145 for monitoring and communicating with submersible 105. Submersible 105 is connected or linked to computer 145 by any communication facility or facilities included in system 100 as schematically illustrated by arrow 148. In certain embodiments, computer 145 can allow a user to remotely operate submersible 105, for example, when submersible 105 must be remotely shut down or directed to collection unite 130 due to an internal error of submersible 105. Submersible 105 is configured to travel along central longitudinal axis 150 and to self-realign when deviating from central longitudinal axis 150, as described in conjunction with FIG. 4.

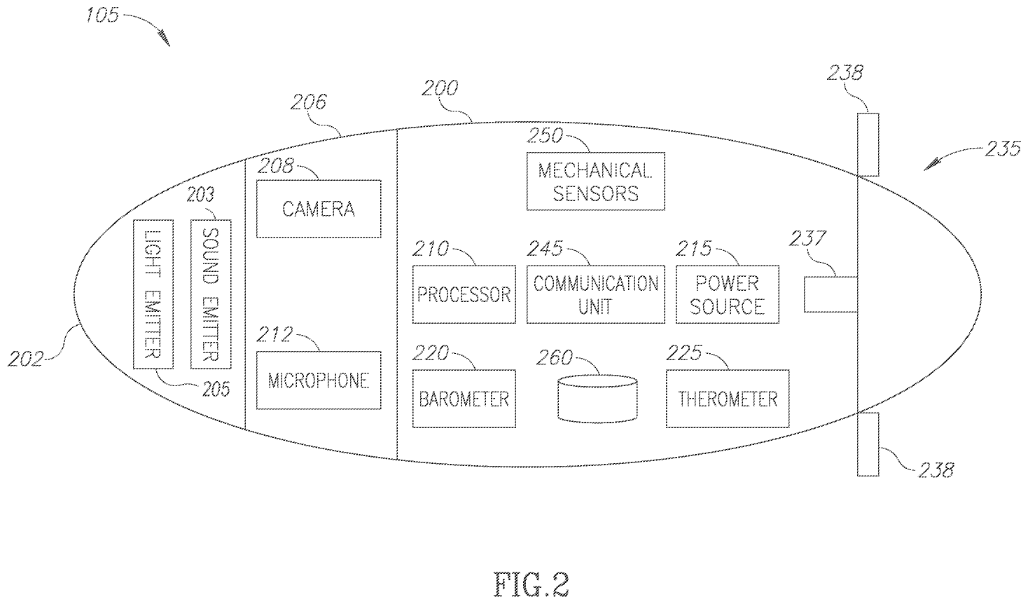

Reference is now made to FIG. 2, schematically illustrating a submersible 105 having a housing 200, a power source 215 and a communication unit 245, according to certain embodiments. Submersible 105 is configured to execute a computer program product, the computer program product includes a non-transitory computer-readable storage medium having program code embodied therewith, the program code executable by at least one hardware processor 210.

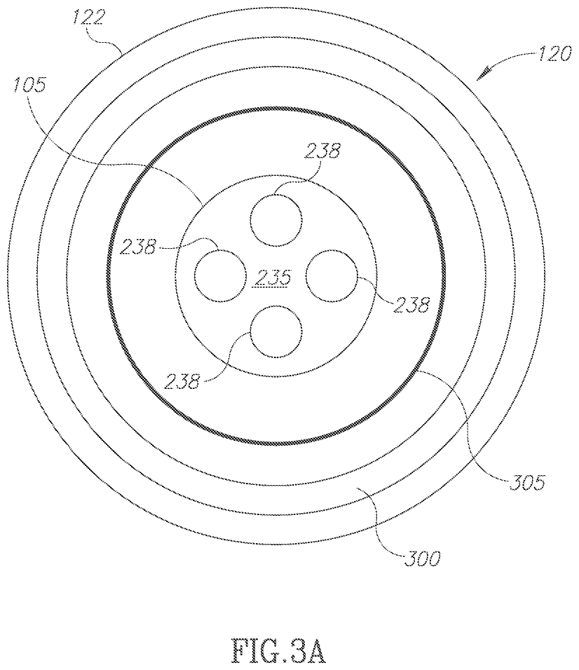

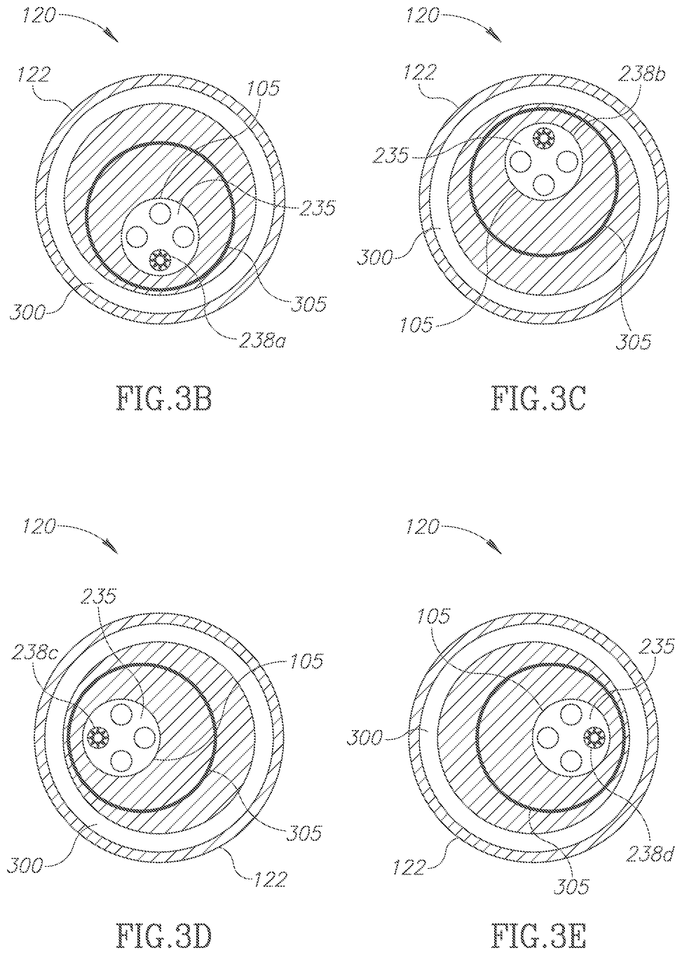

Submersible 100 includes an emission unit 202 configured to emit a predetermined signal. In some embodiments, emission unit 202 includes a light source 205 for emitting light at one or more predetermined wavelengths into fluid carrying channel 120 (FIG. 1). In certain embodiments, light emitter 205 includes one or more light emitting diodes (“LEDs”) (not shown) to provide light at the predetermined wavelengths, for example within the viewable light spectrum. In certain embodiments light emitter 205 can include an infrared light emitter (not shown) to emit light within the infrared light spectrum. In some embodiments, light emitter 205 emits the light in a shape of a ring, such as light ring 300 (FIG. 3). Emission unit 202 can include a sound emitter 203 for emitting wavelengths within the sound spectrum to facilitate detecting irregularities using sonar detection.

The signal emitted from emission unit 202 reflects from inner surface 122 (FIG. 1) and is collected by a sensor unit 206 of submersible 105. In some embodiments, sensor unit 206 includes a camera 208 configured to obtain images of the interior of liquid carrying channel 120. Camera 208 is calibrated to obtain the images in the wavelength spectrum that is emitted by light emitter 205, therefore, if light emitter 205 emits infrared light, camera 208 is calibrated to obtain images showing the infrared image. In some embodiments, sensor unit 206 includes a sound sensor 212, such as a microphone, to collect sound from the interior of liquid carrying channel 120, for example, sound reflecting of a surface of liquid carrying channel 120 that was emitted by sound emitter 203.

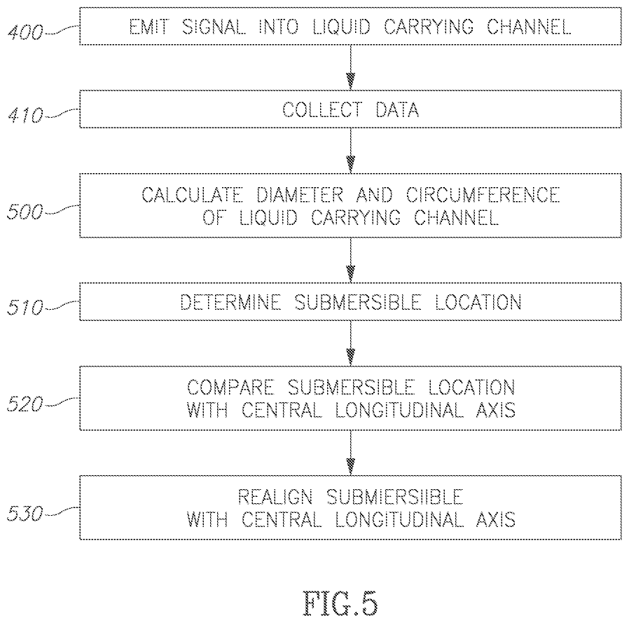

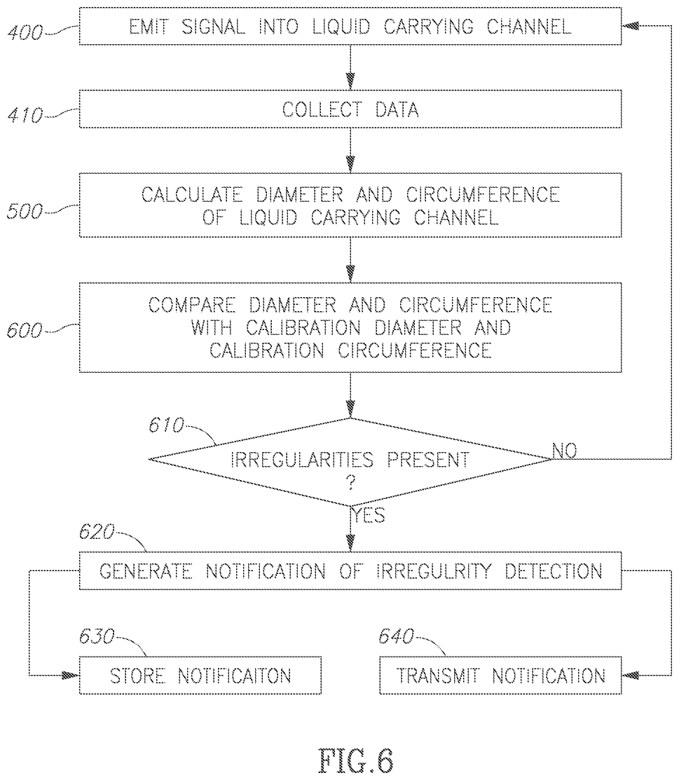

In some embodiments, submersible 105 calculates a calibration ring 305 (FIG. 3), according to an initial signal obtained by sensor 206 when submersible 105 is inserted into liquid carrying channel 120. Calibration ring 305 provides a reference to determine whether or not submersible 105 is aligned with central longitudinal axis 150 and whether irregularities are detected on liquid carrying channel 120. Calibration ring 305 includes a calibration diameter, calibration circumference, a calibration area, and any other relevant value that facilitates detecting irregularities and positioning of submersible 105 within liquid carrying channel 150. In some embodiments, calibration ring 305 is stored in a memory 260 of submersible 105. Calibration ring 305 provides processor 210 with the data by which an irregularity can be detected and the positioning and alignment of submersible can be determined, as described in conjunction with FIGS. 5-6.

In some embodiments, submersible 105 can include one or more mechanical sensors, referenced generally 250, configured to detect the position of submersible 105 from inner surface 122. Mechanical sensors 250 can extend from housing 200 to reach inner surface 122 such that one or more mechanical sensors 250 compress and/or extend to determine thereby providing a signal to processor 210 that submersible 105 has deviated from central longitudinal axis 150. According to the length of extension and/or compression of one or more mechanical sensor 250, submersible 105 travels to realign with central longitudinal axis 150.

Power source 215 can be a rechargeable battery or hydraulic system that utilizing the flow of the fluid in the fluid carrying channel 120 to provide power to submersible 100. Communication unit 245 is configured to enable submersible to communicate with computer 145 (FIG. 1). In some embodiments, submersible 100 can include a barometer 220 and a thermometer 225 to detect the pressure and temperature in fluid carrying channel 120.

In some embodiments, submersible 100 can include a propulsion system 235 to facilitate positioning submersible 100 in a center of liquid carrying channel 120 and to move in a predetermined direction in liquid carrying channel 120. Propulsion system 235 can include a motor 237, one or more propellors, rotors, referenced generally as 238 and/or the like.

Communication unit 245 is configured to provide communication between submersible 105 and computer 145 (FIG. 1) by any communication facility or facilities included in system 100.

Reference is made to FIGS. 3A-3E, schematically illustrating submersible 105 positioned in liquid carrying channel 120, according to certain exemplary embodiments. FIG. 3A schematically illustrates a rear view of submersible 105 positioned in a center axis of liquid carrying channel 120, according to certain exemplary embodiments. Submersible 105 emits a light ring 300 that shines within liquid carrying channel 120, to facilitate determining a diameter and circumference of liquid carrying channel 120. Submersible 105 generates calibration ring 305, which is generated according to a calculation of a calibration diameter and calibration circumference, which are used to determine an alignment and location of submersible within liquid carrying channel 120.

FIG. 3B schematically illustrates a rear view of submersible 105 deviating beneath the center longitudinal axis 150 (FIG. 1) of liquid carrying channel 120, according to certain exemplary embodiments. According to what is described in conjunction with FIG. 5 herein, when submersible 105 determines it has deviated from central longitudinal axis 150 (FIG. 1), a motor, referenced generally 238a, to move submersible 105 to realign with center longitudinal axis 150.

FIG. 3C schematically illustrates a rear view of submersible 105 deviating above the center axis of liquid carrying channel 120, according to certain exemplary embodiments. According to what is described in conjunction with FIG. 5 herein, when submersible 105 determines it has deviated from central longitudinal axis 150 (FIG. 1), a motor, referenced generally 238b, to move submersible 105 to realign with center longitudinal axis 150.

FIG. 3D schematically illustrates a rear view of submersible 105 deviating to the left of the center axis of liquid carrying channel 120, according to certain exemplary embodiments. According to what is described in conjunction with FIG. 5 herein, when submersible 105 determines it has deviated from central longitudinal axis 150 (FIG. 1), a motor, referenced generally 238c, to move submersible 105 to realign with center longitudinal axis 150.

FIG. 3E schematically illustrates a rear view of submersible 105 deviating to the right of the center axis of liquid carrying channel 120, according to certain exemplary embodiments. According to what is described in conjunction with FIG. 5 herein, when submersible 105 determines it has deviated from central longitudinal axis 150 (FIG. 1), a motor, referenced generally 238d, to move submersible 105 to realign with center longitudinal axis 150.

FIG. 4 outlines operation for calibrating submersible 105 (FIG. 1) to determine central longitudinal axis 150 (FIG. 1) of liquid carrying channel 120 (FIG. 1), according to certain exemplary embodiments.

In operation 400, submersible 105 emits a signal into liquid carrying channel 120. The signal emitted can be a light from light emitter 205 (FIG. 2), a sound from sound emitted 210 (FIG. 2), and/or the like. In some embodiments, the light emitted is in a shape of a symmetric ring 300 (FIG. 3).

In operation 410, submersible 105 collects signals from liquid carrying channel 120. Signals are collected by sensor 206 (FIG. 2), for example light reflected from inner surface 122 (FIG. 2) is collected by a light sensor, such as camera 208, or a sound is collected by a sound sensor, such as microphone 212 (FIG. 2).

In operation 420, submersible 105 calculates a calibration diameter and circumference of liquid carrying channel 120 according to the collected signals.

In operation 430, submersible 105 calculates a central longitudinal axis 150 (FIG. 1) according to the diameter and circumference.

In operation 430, central longitudinal axis 150, diameter and circumference are stored in memory 260 (FIG. 2).

It is noted that the operations outlined in FIG. 4 can be optional and in some embodiments, the diameter, the circumference and central longitudinal axis 150 are provided to submersible 105 prior to insertion into liquid carrying channel 120. The diameter, the circumference and central longitudinal axis 150 provide submersible 105 with reference data that facilitate determining whether submersible 105 is aligned according to central longitudinal axis 150 and whether irregularities 160 (FIG. 1) are present on liquid carrying channel 120. According to what is described in conjunction with FIG. 5 herein, when submersible 105 determines it has deviated from central longitudinal axis 150 (FIG. 1), a motor, referenced generally 238c, to move submersible 105 to realign with center longitudinal axis 150.

FIG. 5 outlines operations for realigning submersible 105 (FIG. 1) along central longitudinal axis 150 (FIG. 1) of liquid carrying channel 120 (FIG. 1), according to certain exemplary embodiments. Operations 400 and 410 are executed as described in FIG. 4 above.

In operation 500, submersible 105 calculates a diameter and circumference of liquid carrying channel 120. The diameter and the circumference can be according to a calculation of the diameter and circumference of light ring 300.

In operation 510, submersible 105 determines a location of submersible 105 in liquid carrying channel 120 relative to central longitudinal axis 150.

In operation 520, submersible 105 compares the submersible location with central longitudinal axis 150. Submersible 105 operates propulsion system 235 as described in conjunction with FIGS. 2-3E to realign submersible 105 with central longitudinal axis 150

In operation 530, submersible 105 realigns with central longitudinal axis 150.

FIG. 6 outlines operations for detecting irregularities on liquid carrying channel 120 (FIG. 1), according to certain exemplary embodiments. Operations 400 and 410 are executed as described in FIG. 4 above and operation 500 is executed as described in FIG. 5 above.

In operation 600, submersible 105 compares the diameter and the circumference with the calibration diameter and the calibration circumference respectively.

In operation 610, submersible 105 determines whether irregularities are present along liquid carrying channel 120. Submersible 105 determines whether the diameter and the circumference match the calibration diameter and the calibration circumference. Where the diameter and the circumference does not match the calibration diameter and the calibration circumference, submersible 105 determines an irregularity 160 is detected and therefore performs operation 620. Where the diameter and the circumference match the calibration diameter and the calibration circumference, submersible 105 determines no irregularity 160 is detected and submersible 105 executes operation 400.

In operation 620, submersible 105 generates a notification of irregularity presence. In some embodiments, notification includes a location of irregularity 160 along liquid carrying channel 120, a date and time at which submersible 105 detects irregularity 160, the image obtained of the irregularity 160, and any additional information collected or analyzed by submersible 105.

In operation 630, submersible 105 stores the notification. Notification is stored in memory 260 (FIG. 2) to be provided to computer 145 (FIG. 1) once submersible 105 is extracted from liquid carrying channel 120.

In operation 640, submersible 105 provides the notification to computer 145.

In the context of some embodiments of the present disclosure, by way of example and without limiting, terms such as ‘operating’ or ‘executing’ imply also capabilities, such as ‘operable’ or ‘executable’, respectively. Conjugated terms such as, by way of example, ‘a thing property’ implies a property of the thing, unless otherwise clearly evident from the context thereof.

The terms ‘processor’ or ‘computer’, or system thereof, are used herein as ordinary context of the art, such as a general purpose processor or a micro-processor, RISC processor, or DSP, possibly comprising additional elements such as memory or communication ports. Optionally or additionally, the terms ‘processor’ or ‘computer’ or derivatives thereof denote an apparatus that is capable of carrying out a provided or an incorporated program and/or is capable of controlling and/or accessing data storage apparatus and/or other apparatus such as input and output ports. The terms ‘processor’ or ‘computer’ denote also a plurality of processors or computers connected, and/or linked and/or otherwise communicating, possibly sharing one or more other resources such as a memory.

The terms ‘software’, ‘program’, ‘software procedure’ or ‘procedure’ or ‘software code’ or ‘code’ or ‘application’ may be used interchangeably according to the context thereof, and denote one or more instructions or directives or circuitry for performing a sequence of operations that generally represent an algorithm and/or other process or method. The program is stored in or on a medium such as RAM, ROM, or disk, or embedded in a circuitry accessible and executable by an apparatus such as a processor or other circuitry.

The processor and program may constitute the same apparatus, at least partially, such as an array of electronic gates, such as FPGA or ASIC, designed to perform a programmed sequence of operations, optionally comprising or linked with a processor or other circuitry.

The term computerized apparatus or a computerized system or a similar term denotes an apparatus comprising one or more processors operable or operating according to one or more programs.

As used herein, without limiting, a module represents a part of a system, such as a part of a program operating or interacting with one or more other parts on the same unit or on a different unit, or an electronic component or assembly for interacting with one or more other components.

As used herein, without limiting, a process represents a collection of operations for achieving a certain objective or an outcome. As used herein, the term ‘server’ denotes a computerized apparatus providing data and/or operational service or services to one or more other apparatuses.

The term ‘configuring’ and/or ‘adapting’ for an objective, or a variation thereof, implies using at least a software and/or electronic circuit and/or auxiliary apparatus designed and/or implemented and/or operable or operative to achieve the objective.

A device storing and/or comprising a program and/or data constitutes an article of manufacture. Unless otherwise specified, the program and/or data are stored in or on a non-transitory medium. In case electrical or electronic equipment is disclosed it is assumed that an appropriate power supply is used for the operation thereof.

The flowchart and block diagrams illustrate architecture, functionality or an operation of possible implementations of systems, methods and computer program products according to various embodiments of the present disclosed subject matter. In this regard, each block in the flowchart or block diagrams may represent a module, segment, or portion of program code, which comprises one or more executable instructions for implementing the specified logical function(s). It should also be noted that, in some alternative implementations, illustrated or described operations may occur in a different order or in combination or as concurrent operations instead of sequential operations to achieve the same or equivalent effect.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context clearly indicates otherwise. It will be further understood that the terms “comprises” and/or “comprising” and/or “having” when used in this specification, specify the presence of stated features, integers, steps, operations, elements, and/or components, but do not preclude the presence or addition of one or more other features, integers, steps, operations, elements, components, and/or groups thereof.

As used herein the term “configuring” and/or ‘adapting’ for an objective, or a variation thereof, implies using materials and/or components in a manner designed for and/or implemented and/or operable or operative to achieve the objective.

When a range of values is recited, it is merely for convenience or brevity and includes all the possible sub-ranges as well as individual numerical values within and about the boundary of that range. Any numeric value, unless otherwise specified, includes also practical close values enabling an embodiment or a method, and integral values do not exclude fractional values. A sub-range values and practical close values should be considered as specifically disclosed values.

As used herein, ellipsis ( . . . ) between two entities or values denotes an inclusive range of entities or values, respectively. For example, A . . . Z implies all the letters from A to Z, inclusively.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

Terms in the claims that follow should be interpreted, without limiting, as characterized or described in the specification.

1. A submersible comprising:
at least one sensor configured to collect at least one signal from within an interior area of a liquid carrying channel; and,
at least one processor configured to:
obtain the signal from said at least one sensor;
calculate a diameter and a circumference of a liquid carrying channel according to said at least one signal;
determine whether an irregularity is present on an inner surface of the liquid carrying channel according to the diameter and the circumference; and,
generate a notification to notify that the irregularity has been detected on the inner surface.

2. A submersible according to claim 1, wherein the diameter and the circumference are compared with a calibration diameter and a calibration circumference to determine whether the irregularity is detected on the inner surface.

3. A submersible according to claim 1, further comprising a propulsion system operative to facilitate realigning said liquid proof external casing with a predetermined point of reference.

4. A submersible according to claim 3, wherein the at least one processor is further configured to:
compare the diameter and the circumference with the calibration diameter and the calibration circumference;
determine the housing has deviated from a central longitudinal axis of the liquid carrying channel;
operate the propulsion system to realign housing with the central longitudinal axis.

5. A submersible according to claim 1, further comprising an emission unit configured to emit a signal through the liquid carrying channel.

6. A submersible according to claim 5, wherein
said emission unit is a light emitter for emitting a light ring; and,
said sensor is an imaging sensor for collecting at least one image.

7. A submersible according to claim 5, wherein,
said emission unit is a sound emitter for emitting a sound of a predetermined wavelength; and,
said sensor is a microphone for collecting reflected sound waves.

8. A submersible according to claim 1, further comprising a transmitter for transmitting the notification to a computer.

9. A submersible according to claim 8, wherein the transmitter facilitates remote operation of said at least one processor by a user of the computer.

10. A system configured to detect irregularities on a liquid carrying channel, the system comprising:
a submersible having at least one sensor configured to obtain at least one signal from within an interior area and surface of the liquid carrying channel; and,
at least one processor configured to:
obtain the signal from said at least one sensor;
calculate a diameter and a circumference of a liquid carrying channel according to said at least one signal;
determine whether an irregularity is present on an inner surface of the liquid carrying channel according to the diameter and the circumference; and,
generate a notification to notify that the irregularity has been detected on the inner surface.

11. A submersible according to claim 10, wherein the diameter and the circumference are compared with a calibration diameter and a calibration circumference to determine whether the irregularity is detected on the inner surface.

12. A system according to claim 10, wherein said submersible further comprises a propulsion system operative to facilitate realigning said liquid proof external casing with a predetermined point of reference.

13. A system according to claim 12, wherein the at least one processor is further configured to:
compare the diameter and the circumference with the calibration diameter and the calibration circumference;
determine the housing has deviated from a central longitudinal axis of the liquid carrying channel;
operate the propulsion system to realign housing with the central longitudinal axis.

14. A system according to claim 10, wherein said submersible further comprises an emission unit configured to emit a signal through the liquid carrying channel.

15. A system according to claim 14, wherein
said emission unit is a light emitter for emitting a light ring; and,
said sensor is an imaging sensor for collecting at least one image.

16. A system according to claim 14, wherein,
said emission unit is a sound emitter for emitting a sound of a predetermined wavelength; and,
said sensor is a microphone for collecting reflected sound waves.

17. A system according to claim 10, further comprising:
a computer; and,
a transmitter for transmitting the notification to the computer.

18. A submersible according to claim 18, wherein the transmitter facilitates remote operation of said submersible by a user of the computer.
